(19) United States
(12) Patent Application Publication
(10) Pub. No.: US 2008/0213133 A1
(43) Pub. Date: Sep. 4, 2008

(54) FLOW ANALYSIS APPARATUS AND METHOD

(76) Inventors: Gordon Wallace, Gwynneville (AU); Dermot Diamond, The Ward (IE); King Tong Lau, Bettystown (IE); Shirley Coyle, Fairview (IE); Yanzhe Wu, Kogarah (AU); Deirdre Morris, Clonmel (IE)

Correspondence Address: BROWN RUDNICK LLP, ONE FINANCIAL CENTER, BOSTON, MA, 02111, US

(21) Appl. No.: 12/026,275

(22) Filed: Feb. 5, 2008

Related U.S. Application Data
(60) Provisional application No. 60/899,590, filed on Feb. 5, 2007.

(51) Int. Cl. G01N 21/75; B01J 19/00; G01N 21/00

(52) U.S. Cl. 422/82.05; 422/68.1; 356/338

(57) ABSTRACT

A flow analysis apparatus is disclosed. The flow analysis apparatus has at least one wicking channel fluidically coupled to an absorbent pump. A wicking valve is fluidically coupled to the wicking channel to provide a fluidic connection to the sample source where opening the wicking valve allows the absorbent pump to cause liquid to flow down the wicking channel toward the absorbent pump. Other similar wicking valves can be added to provide functions such as calibration and reagent addition. A detection unit allows for analysis of the liquid as it flows down the wicking channel.

### RELATED APPLICATION INFORMATION

This patent application claims priority to U.S. Provisional Application No. 60/899,590, filed on Feb. 5, 2007, the entire contents of each are incorporated herein by reference.

### BACKGROUND

1. Technical Field

The present disclosure generally relates to a flow apparatus and method and more particularly, to a polymer or fabric fluidic pump that can perform assays.

2. Description of the Related Art

The concept of portable or wearable analytic devices to determine the presence and/or concentration of key target parameters is highly attractive. For example, there are large potential markets for autonomous and networked chemical sensing units for national security and environmental applications, or distributed, wearable diagnostic devices envisaged for pHealth applications. To overcome issues arising from, for example, remote calibration, some type of fluidic platform is usually needed. More recently, the trend has been to miniaturize and integrate the liquid handling aspects of analytical instruments into so-called microfluidic platforms or manifolds. Increasing interest in wearable sensors, including chemo/bio-sensors, has stimulated research into wearable fluidic structures. The desired characteristics of a wearable fluidic platform generally include simplicity and reliability, compliance with wearable structure, preferably made of with fabric, compact and multifunctional, low (ideally zero) power consumption, capability of scale up/down in dimensions and cost base acceptable for predicted applications.

Compared to other approaches, the use of capillary force to wick liquid through a lateral open structure has promising advantages which include the potential for sophisticated control of functions like sample application, reagent addition, inclusion of reaction manifold, separation of sample components, inclusion of a variety of detection modes and addition of calibrants; zero power requirement for the transport of liquid; and compact structure that is easy to fabricate.

Several prior art devices approaches have attempted to address the need for micorfluidic platforms. Once such device is described in U.S. Pat. No. 3,915,647 to Wright, Richard F. et al. in the patent titled “device for determining the concentration of a substance in a fluid.” This patent describes a diagnostic testing device that employs wicking as a means for directing a liquid sample to a particular area for analysis. The platform comprises a liquid receiving cavity, a calorimetric indicator apparatus and a porous wick for connecting the cavity with the colorimetric indicator.

Many improvements on this concept have been achieved in later patents, such as WO Pat. Publication No. 2006018619 “diagnostic testing device using an indicator strip for potable liquids” to Wade, James Henry Charles, et al. which describes the use of wicking material to draw sample liquid from an inlet chamber to the reagent pads. U.S. Pat. Publication No. 20006223193 “diagnostic test kits employing an internal calibration system” granted to Song, Xuedong, et al. describes immunoassay devices that immobilize monoclonal antibodies to CRP on a porous nitrocellulose membrane for detection of C-reactive protein. In another example, WO Pat. No. 9,532,414 ‘antibody detection by qualitative surface immunoassay using consecutive reagent application’ granted to Ma, Bingnan, et al. describes the immobilization of an epitope of an antigen for the detection of the antibody analyte. Additionally, U.S. Pat. No. 6,258,548 “Lateral flow devices using reactive chemistry” granted to Buck, Richard, et al is typical of many such devices as it incorporates a flow device to transporting samples across pre-immobilized dry reagents that react with the sample and generate colored products that can be measured optically.

Generally, most of these devices incorporate a wicking membrane as liquid communication path, a functional wicking surface in certain areas for reaction or detection as defined by the immobilized species, laminated additional structures such as reagent pads, calibration pads or absorbent pads to provide a continuous flow driving force and photo-optical detection via light reflected off or transmitted through a detection area.

Other prior art disclosures make further improvements on the material and structure of the wicking path. For example, U.S. Pat. Publication No. 2002/102739 “Surface-modified wick for diagnostic test strip” to Nomura, Hiroshi, et al. describes the application of low temperature gas plasma treatment to a fibrous wicking material to improve the wicking performance in terms of increased accuracy, finer precision of analyses, reduced time of analysis, etc. WO Pat. Publication No. 2003103835 “Microfluidic structures for sample treatment and analysis systems” to Oehman, Per Ove, et al. Amic A. B., Sweden describes a structure of lateral flow path comprising micro posts protruding upward from the substrate at a small spacing to induce a capillary action for the delivery of sample reagents.

Furthermore, EP Pat. No. 317070 “Digital calorimetric assay and diagnostic device for hydrogen peroxide determination based on threshold color change” describes an analog-to-digital colorimetric device for the detection of concentration threshold of hydrogen peroxide or alcohol, in which the system relies on color change rather than color intensity to estimate concentration, and therefore direct detection in a wide variety of medical and industrial substances is possible.

These devices, however, based on the aforementioned technologies are targeted for single use due to the consumption of a single dose of immobilized reactant upon exposure to sample, or due to changes of the detection surface that requires certain re-calibration procedures that render the device too complex for the envisaged applications. Clearly, a re-usable system, capable of performing multiple assays under user control must overcome additional challenging issues. For example, the liquid handling in particular must be much more sophisticated to accommodate repetitive delivery of reagents to the detection area or programmed deliveries of blank washing liquid, addition of calibrants for the calibration of signal and the re-introduction of sample. Conventional pumps and valves are difficult to down-scale for full integration into a microfluidics platform, consume too much power, are too expensive and tend to become unreliable due to issues arising from particulates being trapped against hard surfaces. Polymers capable of performing muscle like actions (expansion/contraction) at low voltages are an attractive alternative to conventional materials. Inherently conducting polymers (ICPs) are particularly interesting in this regard as it is now possible to electrochemically control and switch the physical volume and the surface tension of ICPs, which make it possible to construct ‘soft’ valves and pumps for the controlled delivery of liquids. FR Pat. No. 2857427 “Electric-control valve comprising a microporous membrane” granted to Garnier, Francis, describes the deposition of electroactive polymer in the pores of the microporous membrane. The polymer seals the pores at either oxidation or reduction state, and the device reversibly functions as a valve suitable for biomedical applications. WO Pat. Publication No. 2003043541 “an electromechanical actuator and method of providing same” granted to Wallace, Gordon George, et al. describes a manufacturing method for making a electromechanical actuator with the potential to be used as mechanical valve for the control of liquid flow.

Therefore, a need exists for a flow analysis apparatus based on polymer, fabric and/or textile materials that provide a platform that can perform multiple assays over extended time periods, under user control. It would be desirable for the apparatus to require a minimal amount of power.

### SUMMARY OF INVENTION

According to the disclosure, a liquid flow analysis apparatus that is based on a fabric system is disclosed. The flow analysis apparatus has at least one wicking channel fluidically coupled to an absorbent pump. The absorbent pump draws liquid entering the apparatus down the wicking channel toward the pump through the use of high water absorbance capacity materials. A wicking valve allows for liquid to come in contact with the wicking channel and enter the apparatus along the wicking channel. It is contemplated that a variety of types of valves may be used in accordance with the present disclosure. A variety of actuators can be implemented to control on/off functions and the flow rate of liquid in the system. A detection unit allows for analysis of the liquid as the liquid flows down the wicking channel. This detection unit can include optical detectors for diagnostic tests based on LEDs for sensitive, low cost detection of color changes, or other optical and electrochemical sensing techniques. The flow analysis system can accommodate component separation, for example, by directing multi-component mixtures through an integrated thin layer chromatographic setup.

In one embodiment, the flow analysis apparatus has moisture wicking fabric fluidically coupled to fabric coated with pH sensitive dye. A light source and photodetector are configured to detect color change in the fabric coated with pH sensitive dye. A mechanical support substantially surrounding the at least one photodetector configured to shield light. As sweat or another fluid is absorbed by the moisture wicking fabric, the fabric coated with pH sensitive dye detects pH and shows a color change. This color change is detected by the photodetector to determine pH of the sweat or other fluid.

A method for flow analysis is also contemplated by the present disclosure. The method includes providing at least one wicking channel fluidically coupled to an absorbent pump; providing at least one wicking valve fluidically coupled to the wicking channel to provide a fluidic connection where opening the wicking valve allows the absorbent pump to cause liquid to flow down the wicking channel toward the absorbent pump; and providing a detection unit that allows for analysis of liquid as liquid flows down the wicking channel.

### BRIEF DESCRIPTION OF THE DRAWINGS

These and other advantages, objects and features of the invention will be apparent through the detailed description of the embodiments and the drawings attached hereto. It is also to be understood that both the foregoing general description and the following detailed description are exemplary and not restrictive of the scope of the invention.

FIG. 1 is a plan cross-sectional view showing the configuration of components in one embodiment of the liquid flow analysis apparatus in accordance with the present disclosure;

FIG. 2 is a cross-sectional view of a wicking valve in the open state in accordance with the present disclosure;

FIG. 3 is a cross-sectional view of a wicking valve in the closed state in accordance with the present disclosure;

FIG. 4 is a perspective view of an example of a bridge-type wicking valve in accordance with the present disclosure;

FIG. 5 is a perspective view of an example of a flap-type wicking valve in accordance with the present disclosure;

FIG. 6 is a graph depicting the changes in the flow rate in accordance with an exemplary embodiment of the present disclosure;

FIG. 7 is a graph depicting the water flux at steady state across various membranes in accordance with the present disclosure;

FIG. 8 is a plan view of an exemplary embodiment in accordance with the present disclosure;

FIG. 9 is a graph depicting Red, Green, Blue (RGB) analysis results in accordance with the present disclosure;

FIG. 10 is a perspective view of an optical detection system of an exemplary embodiment in accordance with the present disclosure;

FIG. 11 is a calibration plot obtained from an exemplary embodiment in accordance with the present disclosure;

FIG. 12 is a graph depicting the first derivative of the previous set of data as shown in FIG. 11 obtained from an exemplary embodiment in accordance with the present disclosure;

FIG. 13 is a perspective view of a dual-channel platform incorporating manual switching valves in accordance with an exemplary embodiment of the present disclosure;

FIG. 14 is a graph of the calibration of a fabric sensor in accordance with an exemplary embodiment of the present disclosure; and

FIG. 15 is a graph depicting PH variations measured in real time taken from a fabric sensor in accordance with an exemplary embodiment of the present disclosure.

### DETAILED DESCRIPTION OF THE INVENTION

The present disclosure relates to the integration of the absorption and wicking capabilities of appropriate textile and fabric structures to enable and control liquid movement, and perform sophisticated analytical operations without an external power source. A further aspect of the invention embodies the use of low power actuators to gate liquid movement and control flow characteristics. The gated textile device as described below has been shown to provide an excellent means of controlling liquid movement for sampling, delivery of reagents and calibrants, reagent/calibrate/sample mixing and on-textile chemical analysis. It is contemplated that the apparatus according to the present disclosure can be applied to a wide variety of potential applications such as wearable sensing systems (personal health), field deployable systems (environment, threat detection), and low cost consumer devices for performing analysis such as biomedical assays, controlled delivery of reagents, drugs, samples, among others.

The sensor apparatus according to the present disclosure comprises several discrete elements enacted in fabric rather than conventional rigid materials (glass, silicon, plastics) typically used to make liquid flow systems. The current disclosure is described in terms of valves, a wicking channel, a detector and a pump made of highly absorbent material.

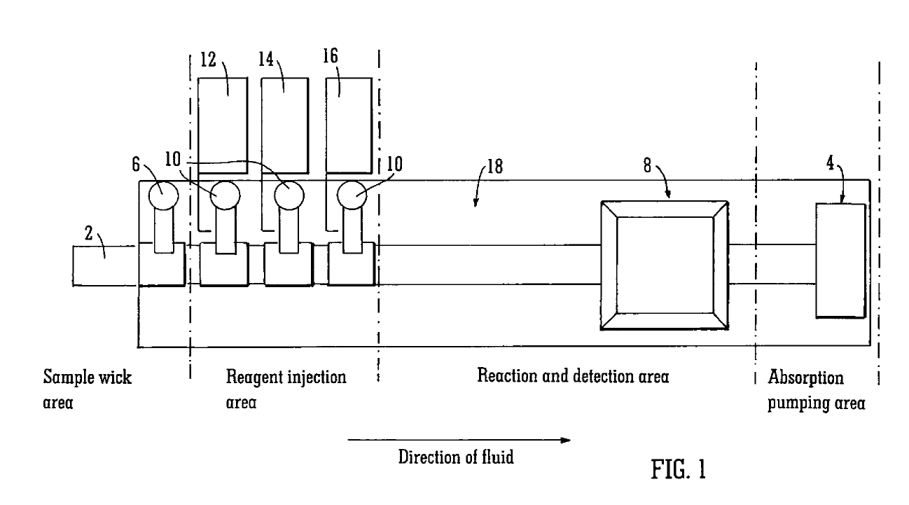

Turning now to the figures, wherein like components are designated by like reference numerals throughout the several views, FIG. 1 illustrates a configuration of components in one embodiment of the flow analysis apparatus in accordance with the present disclosure. A wicking channel 2 connects a pump 4 to the sample or sample carrier source. Variations in the dimensions of the wicking channel 2 such as, length, width and/or height, and in particular, the geometry and extent of the region of contact between the wicking channel 2 and a pump 4 enable the flow rate to be varied considerably. Structures such as ‘Y’ and ‘T’ connections, meanders, etc. can be incorporated as in conventional fluidic systems.

Capillary force is the driver for the liquid flow thought wicking channel 2 toward pump 4. This force may be generated by using a variety of open-pore wicking materials such as fabrics, filtration membranes, micro-sphere composites such as silica plates for thin-layer chromatographic assay or micro-pillar patterned wicking structures. The pump 6 provides liquid driving force and can store fluids that have passed through the apparatus. When the pump 4 is exhausted, it can be replaced with a fresh absorbent and the apparatus can be reactivated. Suitable materials for the pump 4 so that the pump can sustain flow for extended periods of time include certain hydrogels (hydration) or sponges (capillary force) that have a tremendous capacity to absorb many times their own mass of water (e.g. absorbent paper Absorbtex™). This behaviour, combined with microchannels of appropriate dimensions in wicking channel 2, can provide a constant flow over a significant period of time (hours), during which various analytical measurements can be made.

The liquid flow analysis apparatus has four basic structures to perform diagnostic analysis: (1) the wicking valve 6 controls the movement of fluid; (2) the wicking channel 2 guides the direction of fluid, mixing sample liquid with reagent and provides a supporting surface for analyte to be detected; (3) the detection unit 8 provides a signal representing the presence or a specific concentration of an analyte; and (4) the pump 4 provides driving force for liquid movement throughout the apparatus.

In general, the valving function is critical in the liquid flow analysis apparatus according to the present disclosure. The liquid flow analysis of a sample is initiated by the opening of wicking valve 6, which allows the sample liquid to pass into the wicking channel 2. The wicking valve 6 among other valves described below allows the liquid flow to be turned on/off, and allows the introduction of reagents, calibrants and additional samples into the liquid flow analysis apparatus. In a conventional liquid flow apparatus, this is achieved by using mechanical pumps to generate liquid movement, and actuated valves to control liquid direction. Wicking valve 6 incorporates a wicking material that serves as a flow inter-connector between a liquid source, e.g., sample, calibrant, reagent, and the liquid apparatus toward pump 4. In the presence of a flow driving force, a continuous fluidic connection allows liquid to be drawn from the liquid source into the liquid flow apparatus. Making/breaking this inter-connect enables the flow to be turned on/off.

Many displacement actuators can be employed for valve actuation, one example being the operator's finger via a manual toggle switch which requires no internal power supply. For autonomous operations, polymer actuators, electromagnetic, piezoelectric and many other actuation schemes can be utilised to make/break the wicking inter-connect between the liquid reservoirs and the liquid flow analysis apparatus.

The flow rate of the apparatus can also be controlled, for example by including a porous membrane whose permeability can be varied through a functional coating such as inherently conducting polymers (ICPs) and hydrogels, that can swell or contract and thereby control the pore size using an external signal, e.g., redox potential. This effect can be used to control the rate at which reagents, calibrants and sample are allowed to pass into the flow channel. In one manifestation, the effect is generated by coating a porous conducting substrate with an ICP. By changing the applied potential to the ICP through the substrate, the redox state can be switched, which causes swelling/contraction of the ICP, which enables the average pore size to be controlled, and hence the porosity. Combining the wicking valve 6 and porosity filter/valve in the fabric flow analysis apparatus provides a means to incorporate sophisticated liquid control functions that are common in conventional flow apparatuses.

In addition to wicking valve 6, reagent valves 10 are shown in FIG. 1. As the sample travels down the wicking channel 2, the reagent valves 10 are then temporarily opened as appropriate to add small amount of reagents, e.g. reactants and calibrants, into the sample liquid in the wicking channel 2. As shown in FIG. 1, reactants and calibrants are held in a reactant reservoir 12, a calibrant reservoir 14 and a calibrant reservoir 16 until the reagent valves 10 are opened. Travelling further towards the reaction area, sufficient residence time is allowed through, for example, control of the channel length and sample flow rate to ensure adequate mixing and development of reaction products between the sample liquid and reagents, before arriving at the detector 8.

Several approaches can be incorporated to add components such as reactants and calibrants to the flow analysis apparatus. For example, small volumes of liquid can be ‘injected’ into the flowing stream by opening the appropriate valve momentarily. This deposits a small volume of reactant or calibrant into the flowing stream, which is then transported through the flow analysis apparatus. In the case of reagent addition, a wicking valve controls the connection between the reagent reservoir and the liquid flowing in the wicking channel 2. Reagent flows into the stream via the wicking valve and mixes with other components present, e.g. liquid sample. Breaking the contact of the wick with the flow analysis apparatus stops the reagent flow. In the case of calibrants, addition is achieved in the same manner as for reagent addition; except that connection is made through the wicking inter-connect to a calibrant reservoir rather than a reagent reservoir. The calibrant is transported through the flow analysis apparatus and eventually reaches a detector 8, enabling the detector to be calibrated. This apparatus therefore enables stored reagents to be added in controlled amounts at known times.

As liquid enters the apparatus and flows toward the pump 4, the detection unit 8 can be incorporated to serve a variety of analyzing and detecting functions. An operator can use the detection unit 8 to generate an analytical signal. For example, detection unit 8 can be a signal detector. This signal detector can be a photo-detector which is used to monitor changes in the liquid color through time. This can be replaced with a fluorescence or electrochemical detector, or other detection schemes as employed in conventional flow analysis systems. It can also include the operator's visual inspection or other schemes such as digital imaging. Some of these are described in more detail below.

Optical sensing can be incorporated in detection unit 8 provided an absorptive or fluorescent signal is generated, for example, by using analyte sensitive dyes, either immobilized on solid support or in solution. Other examples include immunoassay reagents carrying a detectable label (e.g., luminescence or calorimetric probes) or enzyme-based assays as used in conventional flow analysis systems or biosensors. Quantitative control of amounts of sample and reagent is normally required to detect the concentration of analyte. Usually calibration of the detector is also required to obtain a meaningful and reliable result. It should be appreciated that approaches such as the use of relative retention times of sample components across thin layer chromatographic-like structures within the apparatus can be used to infer unknowns without precise knowledge or control of flow rates, as the approach is inherently relative (flow variations are largely cancelled out as they affect all components equally). This principle is demonstrated below using the separation of pH responsive dye mixtures in a fabric flow analysis apparatus to infer knowledge about the pH.

Electrochemical transducers can also be incorporated. Amperometric, potentiometric, conductometric, coulometric and capacitance measurements can be used as detection methods with this flow analysis apparatus. Bioanalytical elements such as enzymes or antibodies can be immobilized onto the fabric channels directly to produce electroactive species that may be detected using appropriate electrochemical methods. In principle, microelectrodes can also be embedded into the fabric structure to form part of the channel.

The pump 4 according to the current disclosure has the ability to function for many hours, and this coupled with ability to turn on/off means that the apparatus can be activated to perform an assay and then shut down again, reactivated at a later time and the process continued as needed until the pump is exhausted. The pump absorbent material can then be removed and replaced with fresh adsorbent and the apparatus reactivated. Hence this apparatus has the potential to be used for multiple assays over extended periods of time, in contrast to single-use diagnostic platforms which are essentially disposable, with the flow analysis apparatus designed to function over a period of minutes at most.

A supporting substrate 18 is incorporated into the flow analysis apparatus as depicted in FIG. 1. This substrate supports all of the different component parts so that the sample liquid and other added fluids to the apparatus flow down wicking channel 2 toward the pump 4.

Additionally, a cleaning process may be activated by ‘opening’ the appropriate wicking valve which is connected to a cleaning solution source reservoir, to flush out the reacted liquid with a cleaning solution before the next measurement. Thus, the apparatus according to the present disclosure provides that ability to perform repetitive diagnostic tests and the ability to incorporate separation stages for complex multi-component system analysis. The apparatus has the ability to function entirely with no power supply, e.g. visual detection, manual switching of valves using toggle switches, or very low power, e.g. LED based calorimetric measurements, electrochemical measurements, polymer actuator switching of valves. Furthermore, the operation of the flow analysis apparatus according to the present disclosure is fully compatible with fabric structures, making it inherently wearable.

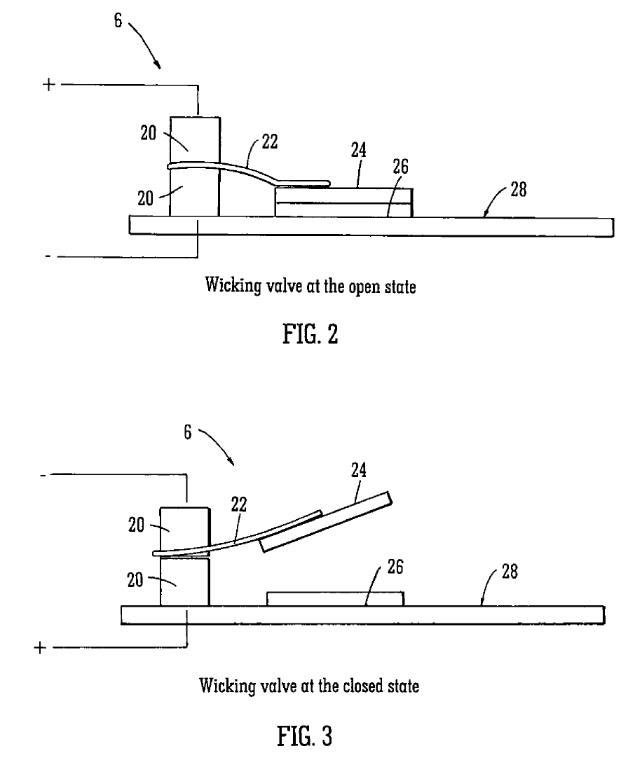

Now referring to FIGS. 2 and 3, a cross-sectional view of the wicking valve 6 and its operation using a conducting polymer actuator is depicted. An electrical clamp 20 is connected to an actuator 22. This wicking valve is a flap-type flow valve using a polypyrrole actuator; if a positive potential (vs. another surface of the polypyrrole actuator) is applied to the upper surface of the polypyrrole actuator 22, the actuator 22 bends and brings the flexible wicking material downwards to make the wicking connection 24 to another wicking channel 26 fixed on a supporting substrate 28. This has the effect of turning liquid movement ‘on’, or opening the valve. In contrast, if a negative potential is applied to the upper surface of polypyrrole actuator, it bends upwards and breaks the wicking connection. This has the effect of turning the liquid movement ‘off’ or closing the valve. FIG. 2 shows the valve at open state. FIG. 3 shows the valve at closed state.

In an exemplary embodiment, the multilayer polypyrrole actuator (1.0 cm×0.2 cm) is connected to an electrical power source at the top and bottom surfaces, and is super-glued to a length of wicking material via a strip (1.0 cm×0.3 cm×100 um, polyethylene), which is used to separate the polypyrrole actuator from the sample liquid. The combined structure is then electrically actuated, with the actuator making/breaking the fluidic connection of one end of the wick with the channel or alternatively, employed to perform the momentary additions of sample, reagents, or calibrant to the wicking channel by touching the flexible wicking material in the valve momentarily against the wicking channel to create the wicking connection 24. One end of the flexible wicking material is immersed in a reservoir of the sample, reagent or calibrant, to be delivered to the wicking channel via the wicking connector 24 when it physically connects with the wicking channel.

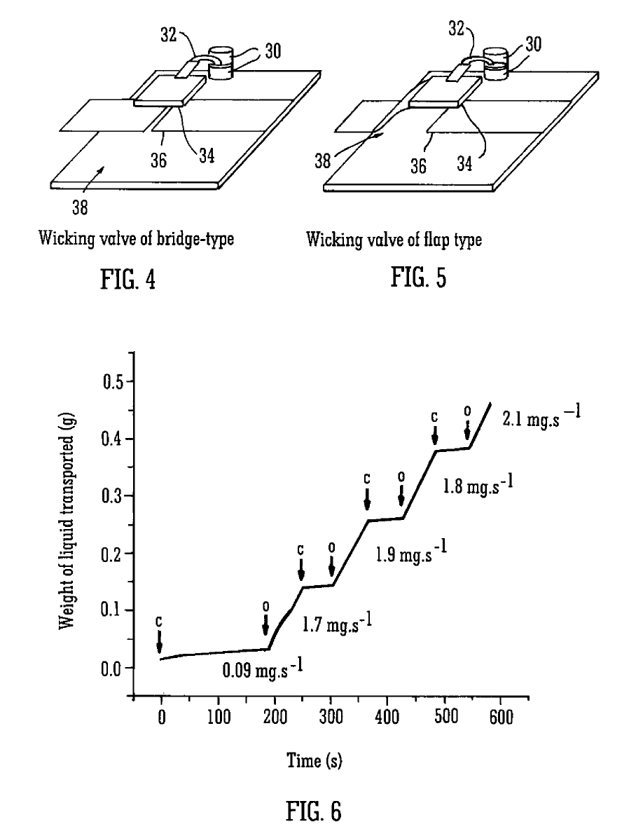

FIGS. 4 and 5 depict examples of wicking valves that can be incorporated into the flow analysis apparatus according to the present disclosure. FIG. 4 illustrates a bridge type valve and FIG. 5 depicts a flap type valve. In each Figure an electrical clamp 30 is connected to an actuator 32. As shown in FIG. 3, if a positive potential (vs. another surface of the polypyrrole actuator) is applied to the upper surface of the actuator 32, the actuator 32 bends and brings the flexible wicking material downwards to make the wicking connection 34 to another wicking channel 36 fixed on a supporting substrate 38. This has the effect of turning liquid movement ‘on’, or opening the valve. In contrast, if a negative potential is applied to the upper surface of actuator 32, it bends upwards and breaks the wicking connection. This has the effect of turning the liquid movement ‘off’ or closing the valve.

A variety of materials can be incorporated into the apparatus according to the present disclosure. In one example, Nylon lycra textile (80% nylon, 20% lycra yarns, warp knitted), silica gel plate (Fluka 89070), absorbent paper (Absorbtex™, Texsus, 16 mg·cm⁻²), PMMA plate (length/width/thickness: 6 cm×4 cm×2 mm), super glue, polypropylene film (thickness: 100 μm) and magnetic connectors (Maplin, Dublin) were obtained from commercial sources and used as received. Micro-pillar wicking slides (Amic A B, Sweden) were obtained as gifts from the Biodiagnostic Institute, Dublin City University. Pyrrole (Merck) was distilled and stored under nitrogen at −20° C. before use. Dodecylbenzenesulfonic acid sodium salt (NaDBS, Aldrich), methyl blue (Aldrich), methyl orange (Aldrich), 1,10-phenanthroline (Aldrich), Fe(II) chloride (Aldrich) and phenol red (Aldrich) were used as received without further purification.

A hydrophilic type filter membrane (Millipore) was used for the fabrication of a porous valve. It is of 0.45 μm pore size and 75% porosity with a nominal thickness of ˜110 μm.

Polypyrrole actuators were constructed according to procedures fully described in the literature (see Wu, Y. et al, 2006). Artificial sweat was prepared according to ISO standard 3160/2. It contains 20 g·L⁻¹ sodium chloride (Aldrich), 17.5 g·L⁻¹ ammonium chloride (Aldrich), 5 g·L⁻¹ urea (Aldrich), 2.5 g·L⁻¹ acetic acid (Aldrich) and 15 g·L⁻¹ lactic acid (Aldrich). Artificial sweat samples at various pH values were prepared by addition of 0.1 M aqueous solution of sodium hydroxide or hydrochloride acid.

In one embodiment the pump 4 as depicted in FIG. 1 is made by multilayered absorbent papers laminated on the wicking channel. The absorbent papers (each 1 cm×1 cm square) are held by a pair of magnetic clamps to maintain a constant contact to the fabric strip that acts as a flow channel (5 cm×1 cm). A volume increase of absorbent occurs during the absorption of liquid. The combined structure provides a form of ‘liquid pumping’ by the absorption process which results in liquid movement through the interconnected channels.

The flow or wicking channel 2, as depicted in FIG. 1 can be patterned on fabric using silicone rubber. Alternatively, in another embodiment, the wicking channel 1 is cut from a piece of bulk fabric. For the later, a strip (5 cm×1 cm) is cut from Nylon Lycra fabric along the knitting groove for use as the wicking channel. It is then laminated onto a solid support (PMMA, 6 cm×4 cm) using double-sided adhesive tape as the intermediate layer. The wicking channel 2 is usually designed to accommodate different functions at different areas. For example, sufficient length at the reaction area is usually allowed for adequate mixing of sample with reagents and to complete the development of reactions before reaching the detection area, while at other locations, the channel width can be constructed to regulate overall flow.

Another approach to controlling flow and/or reagent addition is to use porous flow valves or filters such as a membrane with variable pore size. In one embodiment, this is fabricated from a porous PVDF membrane which is sputter-coated with platinum (˜70 nm thick) followed by electrochemical deposition of a layer of polypyrrole which partially fills the open cavities. The polypyrrole is grown galvanostatically at a current density of 1.0 mA·cm⁻² for 600, 700 and 800 seconds, respectively, from aqueous solutions containing 0.1 M pyrrole and 0.1 M NaDBS. The as-prepared membrane is then rinsed thoroughly with Milli-Q water to remove residues of pyrrole and NaDBS and used as an interconnector (a valve) between two wicking channels.

### Examples of Modes of Use and Illustrative Measurements

Operation of Wicking Valve

The operation and effectiveness of one embodiment of the wicking valve 2 is demonstrated using a polypyrrole flap-type valve to measure the amount of liquid passing through the wicking flow valve to the absorbent. 10 ml of artificial sweat was added to a petri-dish container which was then placed on a digital microbalance. A free standing fabric channel (0.2 cm wide and 3.0 cm long) was dipped into this solution and connected to the flow analysis apparatus through the valve.

Referring to FIG. 6, changes in the flow rate of artificial sweat are shown in response to the repetitive switching of a wicking valve that was actuated using a polypyrrole actuator. The wicking channel had a width of 0.50 cm and a length of 5.0 cm. In FIG. 6, C=valve closed and O=valve open. Initially the valve was ‘closed’, and the rate of liquid loss was measured as ·0.09 mg·s⁻¹ (shown as a relatively flat baseline), which in fact corresponds to the rate of water evaporation at room temperature from the open petri dish. When the valve was first switched to open, the rate of liquid flow rapidly increased to 1.7 mg·s⁻¹ (shown as steep line). The wicking valve 2 was repetitively switched open/closed 4 times and a relatively reproducible switching of liquid flow was obtained, 0.09 mg·s⁻¹ for the “closed” and 2.0 mg·s⁻¹ for the “open”.

Polypyrrole Based Porous Valve Filter

The operation and effectiveness of another embodiment of flow control has been demonstrated using a polypyrrole permeable membrane to control the amount of liquid passing through a flow-through cell (dia. 0.8 cm) at a constant pressure (˜4 mbar) by using the swelling/contraction of PPy on a porous substrate to vary the effective pore size, and hence the permeability.

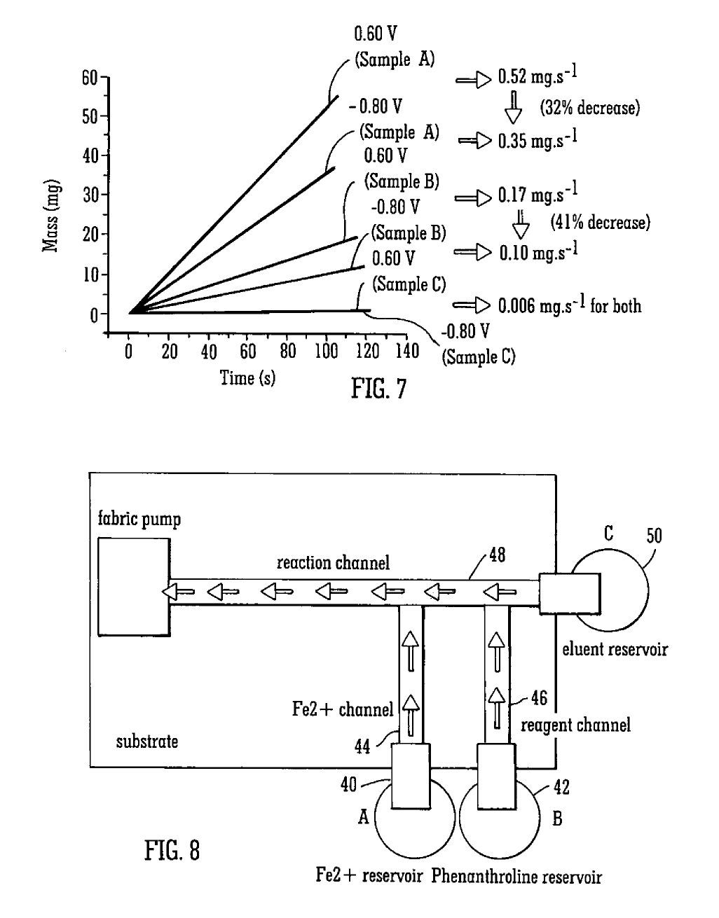

Referring to FIG. 7, water-flux at steady state across PPy/Pt/PVDF membranes for samples A, B and C at +0.60 V and −0.80 V (vs. Ag/AgCl), respectively are shown. Three samples of PPy/Pt/PVDF membranes were prepared as follows; three samples of PPy/PtPVDF membranes were prepared from a porous PVDF filtration membrane. This PVDF membrane of ˜110 um in thickness and was firstly sputter coated with a thin layer of platinum (average thickness 70 nm). A layer of polypyrrole was then galvanostatically deposited on the platinum coated PVDF membrane at a current density of 1.0 mA·cm⁻² from an aqueous solution containing 0.1 M pyrrole and 0.1 M Na·DBS. The deposition time of polypyrrole was varied to control the thickness of polypyrrole layer, 600 seconds for sample A, 700 seconds for sample B and 800 seconds for sample C. Using sample A of a PPy coated PVDF membrane, the flow rate at the oxidized state was found to be ˜0.52 mg·s⁻¹. Upon switching to the reduction potential of −0.80 V, the polymer swells and partially occludes the pores, and the flow rate decreased by 32% to 0.35 mg·s⁻¹. The largest change in flow rate was obtained for sample B. In this case, the flow rate at the reduction potential of −0.80 V decreased by 41% to from 0.17 mg·s⁻¹ (at the oxidation potential +0.60V) to 0.10 mg·s⁻¹.

These results indicate that it possible to control the flow rate to a significant degree by variable porosity/permeability, and while it is not demonstrated here, in principle it should be possible to change between effectively ‘off’ and ‘on’ states by further tuning this effect, or by using the switchable pore size to control the passage of appropriately sized beads loaded with reagents or calibrants.

Quasi-Quantitative Measurement of Fe(II) Concentration

In the example shown in FIG. 8, 1,10-phenanthroline was used as a chelating agent and indicator for metal ions, such as Fe(II) which turns to a deep red color in the presence of this reagent. This example incorporated the use of a wicking channel as a reaction manifold. FIG. 8 depicts a schematic representation of the set up. An Fe(II) valve 40 is used to control the introduction of Fe(II) into an Fe(II) channel 44, and a reagent valve 42 to control the introduction 0.10 M phenanthroline into the reagent channel 46. Reagent valve 42 allows the reagent to enter into the eluent flowing right to left along the wicking channel 48, which is controlled by a eluent valve 50. When Fe(II) valve 40 is opened, Fe(II) ions enter the main wicking channel 46, mixes with phenanthroline (reagent valve 42 open) and the characteristic red colored complex is seen to form downstream.

Sufficient supply (excess) of 1,10-phenanthroline is maintained by means of a wider channel width (1.0 cm) and higher concentration of 0.10 M compared to a maximum of 0.01 M Fe(II). By varying the Fe(II) concentration, different intensities of the red color can be achieved that can be related to the concentration of Fe(II), thus demonstrating the quantitative capabilities of the system.

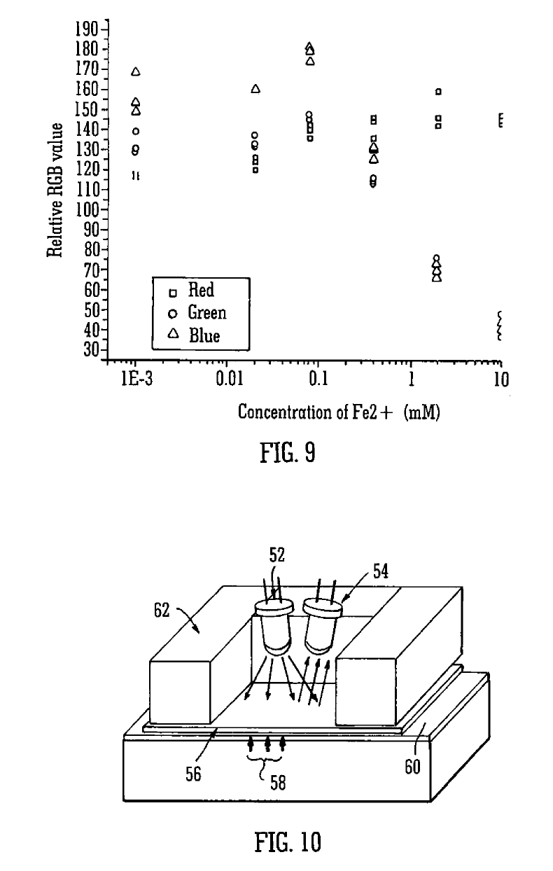

Various means including digital imaging or calorimetric measurements can be used to monitor changes in color. For example, Red, Green, Blue (RGB) analysis of digital images obtained with a video camera is depicted in FIG. 9. The RGB analysis of video images of the reaction surface of fabric strip for the Fe(II) from 0.001 mM to 10 mM, showing the quantitative response to Fe(II) concentration in the green and blue channels at higher concentrations followed a logarithmic relationship between the green or blue channels and the concentration of Fe(II). When the concentration of Fe(II) increased from 0.02 mM to 10 mM, its logarithmic value is linearly related to the intensity of green or blue color according to RGB analysis. The result was due to the fact that the red colored [Fe(phen)³]²⁺ complex absorbed in the green and blue region of the visible light spectrum. Other colorimetric detectors could be substituted for the video camera to obtain quantitative measurements using this approach, such as reflectance colorimetry, which is described in the following section.

On-Fabric pH Sensor

pH indicator dye or other chromo-reactive dyes may be immobilized within the flow analysis apparatus either onto the surface of components incorporated into the apparatus or onto the textile substrate itself and the color may be monitored using either a transmission or reflectance mode configuration. LEDs have been chosen to illustrate optical sensing as they are versatile components that have been demonstrated to operate as effective detectors as well as light sources. Operating LEDs as the light source and detector provides a low-cost and low-power solution to colorimetric measurements which is desirable for any wearable application. One embodiment of the LEDs for reflectance colorimetry is depicted in the example shown in FIG. 10. A LED 52 in combination with a photodetector 54 is set up to detect color from a fabric coated with pH sensitive 56. Fabric 56 detects pH when sweat 58 is drawn into moisture-wicking fabric 60. LED 52 and photodetector 54 are surrounded by a mechanical support 62. It is contemplated that other arrangements can be used for transmission or fluorescence measurements, and other optical detectors and energy sources can be substituted for the LEDs.

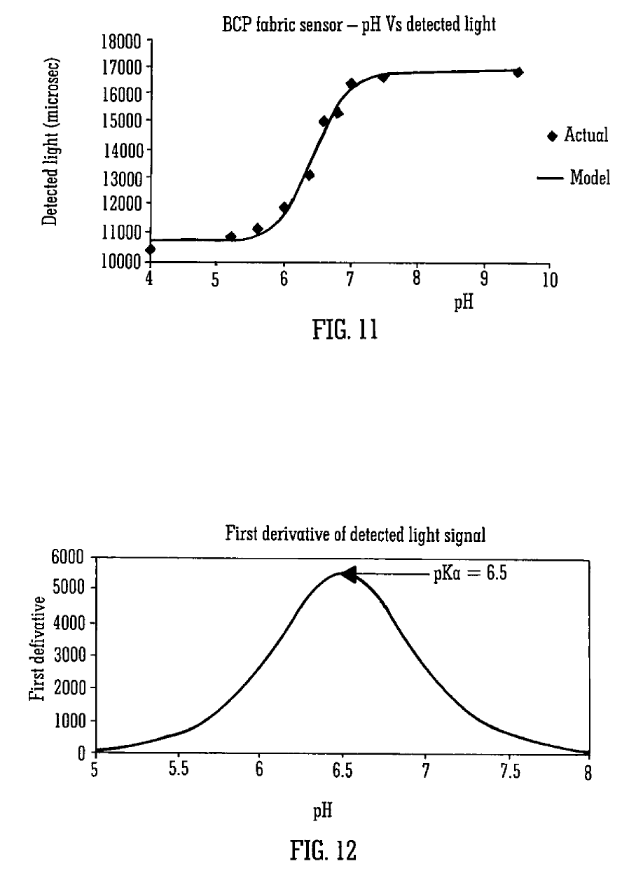

Immobilization of the dye onto the textile is an attractive approach, as the textile itself becomes the sensor. In this example, bromocresol purple, a pH indicator dye with pKa at 6.20 was used to demonstrate the principle. The dye was first immobilised onto a portion of the fabric channel which was connected to the absorbent fabric pump. The pH sensitive dye immobilized onto the textile substrate exhibits reversible color changes depending on the pH of the sample. The results are shown in FIGS. 11 and 12. FIG. 11 shows the calibration plot obtained from the optical sensor as depicted in FIG. 10. FIG. 12 shows the first derivative of the data to obtain the pKₐ of the immobilized dye, with the pKa estimated at 6.5, which is reasonably accurate bearing in mind the dye is surface immobilized.

ph Detection Using Thin Layer Chromatographic Technique

Another possible set-up that may be used is the thin layer chromatographic (TLC) separation of dyes using artificial sweat (pH 2) as the running fluid. A first wicking valve (V1) can control the flow of a sweat eluent and a second wicking valve (V2) can control the introduction of a sample of the dye mixture into the flowing eluent. When both valves are closed and there is no liquid movement in an apparatus according to the present disclosure. When V1 is opened, making contact between an eluent reservoir and a wicking apparatus through the valve wick, the eluent begins to flow through the apparatus according to the present disclosure. V2 can then be opened and deposit a sample of the dye mixture into the liquid flow analysis apparatus. V2 can be closed almost immediately again and the sample mixture may be carried downstream towards the highly absorbent fabric pump across a TLC surface where the dyes begin to separate. The separation progresses as the mixture advances towards the absorbent pump (the pump can be seen to the right of the indicator reservoir in contact with the wicking channel).

The same process may be carried out again using the thin layer chromatograph for separation of dyes using artificial sweat (pH 5) as the eluent. Dye separation depends on pH due to changes in the form of the acidochromic dyes, which is reflected in the relative retention times of the observed colors. Consequently, the color pattern obtained can be used to infer the pH of an unknown sample. In contrast from lower pH sweat, the red component would be transported more rapidly than the blue component across the TLC surface (pH 2 eluent), whereas the blue component is transported more rapidly (pH 5 eluent). Hence by observing which dye elutes first in accordance with the present disclosure, knowledge of the pH can be obtained.

With V1 open, the artificial sweat, wicks along a silica plate, and a continuous liquid flow can be maintained. V2 can be momentarily opened to add small amount of reagent (˜5 μl) containing equal amount of methyl blue and methyl orange (0.5 mM). The separation of methyl blue and methyl orange on the silica plate may be recorded by a video camera and using the relative migration rate of the dyes (which is related to ionization, which in turn is related to pH), it is possible to estimate the pH of a sample solution into which the dye mixture is added. For example, at the pH 2, methyl orange is always in front of methyl blue, while at the pH of 5, methyl blue is always in front of methyl orange. Therefore, by allowing the dyes to separate, and detecting the relative rate of migration through the apparatus, the pH can be determined. This concept is generic and can be applied to many applications where the relative rate of migration of components of a dye mixture is affected by interactions with a sample analyte.

Zero Power Fabric Fluidic Apparatus

In the examples described above, control of valving is illustrated by means of very low power polymer actuators, and detection is possible through a variety of low power optical and electrochemical sensing approaches, giving rise to an overall low power fabric analytical platform. However, it is possible to generate a zero power analytical fluidic platform that is capable of performing quite sophisticated analytical procedures and assays. In this example, the wicking valve can be manually actuated and detection of the result is achieved using calorimetric assays and visual inspection. As the pump and sample/reagent transport requires zero power, the entire apparatus is power free, and yet multiple assays involving, for example, reagent addition, reactions leading to colored products, separation of colored markers, and detection by eye, can be performed.

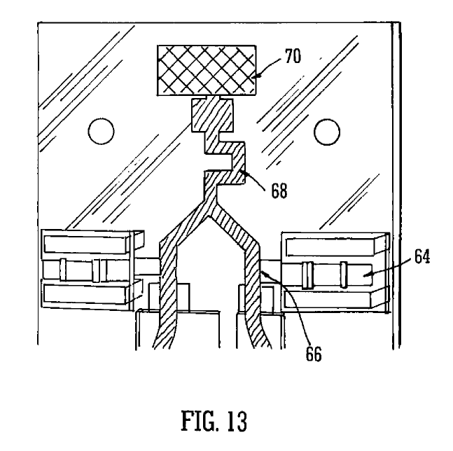

An example of this is shown in 13. FIG. 13 illustrates a dual-channel platform incorporating manual switching valves. A manual toggle switches allow control of the addition and mixing of buffer solutions. A fabric valve controlled by the toggle switch 66 allows an eluent to travel through a fabric channel 68 toward absorbent material 70. Toggle switches may used to control liquid flow from both channels towards the absorbent pump. For one example, pH indicator bromocresol purple (BCP) may be mixed with pH 4 buffer solution resulting in a yellow color at the optical detection region. In contrast, the same pH indicator bromocresol purple (BCP) mixed with pH 7 buffer solution results in a blue/purple color at the at the optical detection region.

From this, it is evident that such toggle switches could be incorporated as part of, for example, a wearable garment, and the sample and reagent additions controlled manually using these valves, and reactions carried out leading to the generation of analytical information. Furthermore, the apparatus can be shut down until required at a later time using the same toggle switches, which allows multiple assays to be performed with a single unit.

It will also be possible to incorporate battery-like structures using, for example, metallic films such as Zn and Cu, with a porous fabric inter-connect which absorbs sample electrolyte and is activated in the process, and capable of providing the small amounts of power required to allow the polymer actuators and sensors to function, and communicate to a remote location, with no conventional power supply required. In this manifestation, the batteries will only become energized in the presence of the sample, e.g. sweat, urine or other electrolytes.

Wireless System Incorporating Fabric Fluidic Apparatus

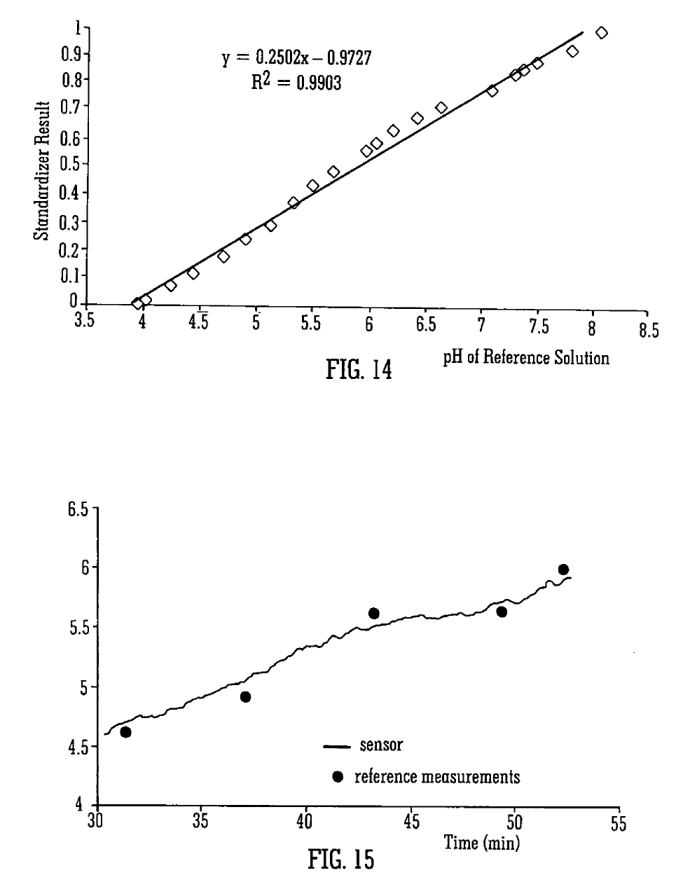

Now referring to FIGS. 14-15. A fabric pH LED reflectance sensor according to the present disclosure was powered and controlled by a wireless system which transmits a measurement of detected light to the remote base station. The sensor was calibrated in-vitro using reference solutions of artificial sweat with values from pH 4-8 and a standardized result obtained. The calibration of the fabric pH LED reflectance sensor using reference

For on-body trials, the sensor is worn by a subject who cycles for 30 minutes to prime the system. After this, real-time measurements are recorded. pH values were obtained by comparison with the standardized calibration curve. Reference measurements were made by placing a calibrated reference pH flat-tipped glass electrode in contact with the sweat using a fabric sampling unit. FIG. 15 shows pH variations measured in real time using the wearable pH fabric sensor during the course of a workout on an exercise bicycle. Excellent agreement with the reference measurements is evident (generated using a calibrated reference pH flat-tipped glass electrode in contact with the sweat using a fabric sampling unit).

The principles, preferred embodiments and modes of operation of the presently disclosed have been described in the foregoing specification. The presently disclosed system, however, is not to be construed as limited to the particular embodiments shown, as these embodiments are regarded as illustrious rather than restrictive. Moreover, variations and changes may be made by those skilled in the art without departing from the spirit and scope of the instant disclosure and disclosed herein and recited in the appended claims.

What is claimed is:

1. A flow analysis apparatus comprising:
at least one wicking channel fluidically coupled to an absorbent pump;
at least one wicking valve fluidically coupled to the wicking channel to provide a fluidic connection where opening the wicking valve allows the absorbent pump to cause a liquid to flow down the wicking channel toward the absorbent pump; and
a detection unit that allows for analysis of the liquid as the liquid flows down or reaches the end of the wicking channel.

2. The liquid flow analysis apparatus according to claim 1, wherein the wicking channel is made of fabric.

3. The liquid flow analysis apparatus according to claim 1, further comprising at least one reagent valve fluidically coupled to the wicking valve to allow addition of at least one reagent.

4. The liquid flow analysis apparatus according to claim 3, further comprising a reagent adding area defining at least one reagent reservoir to hold at least one reagent to be added to the liquid analysis apparatus.

5. The flow analysis apparatus according to claim 3, wherein the reagent is a calibrant.

6. The flow analysis apparatus according to claim 3, wherein the reagent is a reactant.

7. The flow analysis apparatus according to claim 1, wherein the absorbent pump is made of highly absorbent material.

8. The flow analysis apparatus according to claim 1, wherein the wicking valve is a bridge-type valve.

9. The flow analysis apparatus according to claim 1, wherein the wicking valve is a flap-type valve.

10. The flow analysis apparatus of claim 1, the detection unit comprising at least one optical sensor for flow analysis.

11. The flow analysis apparatus of claim 1, further comprising an electrochemical transducer for flow analysis.

12. The flow analysis apparatus of claim 1, further comprising pH detectors for pH analysis of the fluid.

13. The flow analysis apparatus of claim 1, further comprising pH indicators incorporated into the wicking channel to allow for pH analysis of sweat or other liquids.

14. The flow analysis apparatus according to claim 1, further comprising an actuator coupled to the wicking valve to allow for liquid flow rate control.

15. The flow analysis apparatus of claim 1, further comprising a porous membrane displacement actuator coupled to the wicking valve to control flow rate of liquid or small particulates like beads through variations in permeability of the porous membrane.

16. The flow analysis apparatus of claim 1, further comprising a manual toggle switch to control the flow rate of the fluid.

17. The flow analysis apparatus of claim 1, further comprising a wireless system which transmits a measurement of detected light to a remote base station.

18. A flow analysis apparatus comprising:
moisture wicking fabric fluidically coupled to fabric coated with pH sensitive dye;
at least one light source;
at least one photodetector operatively coupled to the light source configured to detect color change in the fabric coated with pH sensitive dye; and
a mechanical support substantially surrounding the at least one photodetector configured to shield light.

19. The flow analysis apparatus of claim 18, wherein the light source is an LED.

20. A method for flow analysis comprising:
providing at least one wicking channel fluidically coupled to an absorbent pump;
providing at least one wicking valve fluidically coupled to the wicking channel to provide a fluidic connection where opening the wicking valve allows the absorbent pump to cause liquid to flow down the wicking channel toward the absorbent pump; and
providing a detection unit that allows for analysis of liquid as liquid flows down the wicking channel.

21. The method of claim 20, further comprising the step of providing a wireless system which transmits a measurement of detected light to a remote base station.

22. The method of claim 20, wherein the detection unit is an optical sensor system.
